(19) United States
(12) Patent Application Publication
(10) Pub. No.: US 2017/0276625 A1
(43) Pub. Date: Sep. 28, 2017

(54) ELECTRO-MAGNETIC INDUCTION FLUID CONDUCTIVITY SENSOR

(71) Applicant: Rockland Scientific International Inc., Victoria (CA)

(72) Inventor: Rolf Gero Lueck, Victoria (CA)

(21) Appl. No.: 15/505,673

(22) PCT Filed: Aug. 11, 2015
(86) PCT No.: PCT/CA2015/050756

§ 371 Date: Feb. 22, 2017

Related U.S. Application Data
(60) Provisional application No. 62/040,581, filed on Aug. 22, 2014.

(51) Int. Cl. G01N 27/08; G01N 27/02

(52) U.S. Cl. CPC G01N 27/08; G01N 27/025

(57) ABSTRACT

An electro-magnetic induction fluid conductivity sensor is described which includes a hollow non-conductive body defining a fluid chamber. The fluid chamber has a first end and a second end. A voltage transformer is provided which is capable of inducing an electric field into fluid positioned within the fluid chamber, thereby causing an electric current to flow through the fluid. An instrument is provide for measuring the electric current. A conductive shunt receives the electric current induced by the voltage transformer in the liquid at the first end of the sample chamber and returning the electric current to the second end to complete an electrical circuit.

This application is a national stage completion of PCT/CA2015/050756 filed Aug. 11, 2015 which claims priority from U.S. Provisional Application No. 62/040,581 filed Aug. 22, 2014.

### FIELD

There is described a sensor that measures electrical conductivity of a fluid by electro-magnetic induction.

### BACKGROUND

Electro-magnetic induction fluid conductivity sensors are adversely affected by the relative conductivity of surrounding fluid and by the relative conductivity of objects within the surrounding fluid.

There will hereinafter be described an electro-magnetic induction fluid conductivity sensor that is not as affected by such external influences.

### SUMMARY

There is provided an electro-magnetic induction fluid conductivity sensor which includes a hollow non-conductive body defining a fluid chamber. The fluid chamber has a first end and a second end. A voltage transformer is provided which is capable of inducing an electric field into fluid positioned within the fluid chamber, thereby causing an electric current to flow through the fluid. An instrument is provide for measuring the electric current. A conductive shunt receives the electric current induced by the voltage transformer in the liquid at the first end of the sample chamber and returning the electric current to the second end to complete an electrical circuit.

The electro-magnetic induction fluid conductivity sensor described above has a built in flow path through the conductive shunt. The readings of this sensor is not adversely affected by the relative conductivity of surrounding fluid or by the relative conductivity of objects within the surrounding fluid. The sensor can be wholly submerged within the fluid be measured.

The conductive shunt can take various forms. One form, as hereinafter illustrated and described, includes a first conductive element connected to the body at the first end of the fluid chamber, a second conductive element connected to the body at the second end of the fluid chamber and a conductive link connecting the first conductive element and the second conductive element.

The body can take various forms, as can the first conductive element and the second conductive element. If a cylindrical body is used having a longitudinal axis, beneficial results have been obtained when the first conductive element is a first tubular metal extension and the second conductive element is a second tubular metal extension. It is preferred that the first tubular metal extension and the second tubular metal extension are co-axial with the longitudinal axis of the cylindrical body.

Conventional construction of an electro-magnetic induction fluid conductivity sensor would have a cylindrical body with the voltage transformer toroidal-shaped and surrounding the cylinder body and the current transformer toroidal-shaped and surrounding the cylinder body. There are, however, advantages in using other configurations. For example, the voltage transformer and the current transformer can be disposed within a housing connected to the body, with the second conductive element forming a conductive inner wall for the housing. With this configuration the non-conductive body extends away from the housing in cantilever fashion where the body is exposed to fluid on an exterior of the body, in addition to fluid within the fluid cavity. Where thermal sensitivity is of concern, exposure to fluid on both inside and outside surfaces results in accelerated thermal equalization of the body and the fluid being measured.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view, in partial section, of a first embodiment of electro-magnetic induction fluid conductivity sensor.

FIG. 2 is a side elevation view, in section, of the first embodiment of electro-magnetic induction fluid conductivity sensor illustrated in FIG. 1.

FIG. 3 is a side elevation view, in section, of a second embodiment of electro-magnetic induction fluid conductivity sensor illustrated in FIG. 1.

FIG. 4 is a side elevation view, in section, of the first embodiment of electro-magnetic induction fluid conductivity sensor illustrated in FIG. 1, adapted for use in pumping applications.

FIG. 5 labelled a PRIOR ART is a side elevation view, in section, of a prior art electro-magnetic induction fluid conductivity sensor.

### DETAILED DESCRIPTION

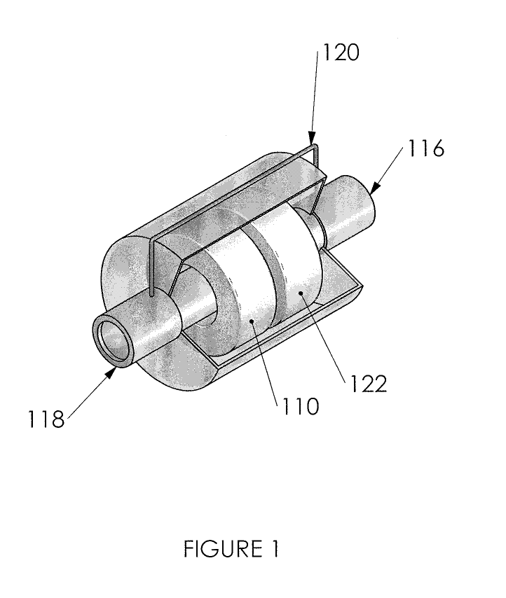

An electromagnetic induction fluid conductivity sensor generally identified by reference numeral 100, will now be described with reference to FIG. 1 through FIG. 5.

### Prior Art

In order to provide context for electro-magnetic induction fluid conductivity sensor 100, there will first be described a Prior Art electro-magnetic induction fluid conductivity sensor, generally identified by reference numeral 10. Prior Art sensor 10 has a body 12 that has the approximate shape of a cylinder with an outer-wall 14, an inner-wall 16 and end-walls 18 and 20 that are non-conductive. A toroid shaped transformer (voltage transformer 22), embedded in a chamber 24 formed by the cylinder walls, induces an electric field, shown by field lines 30, in the fluid causing an electric current to flow through the fluid within a fluid chamber 32 defined by inner wall 16. Fluid chamber 32 bounded by inner cylindrical walls 16 is usually called “the sampling volume”. The length of fluid chamber 32 defines the axial range of the sampling volume, as indicate by arrows 34. A second, coaxially placed, and torrid-shaped transformer (current transformer 36) senses the electric current flowing through the fluid contained within fluid chamber 32. The ratio of the resultant current to the induced voltage is proportional to the electrical conductivity of the fluid. Electric circuits that may be located internally or externally to the sensor produce signals related to the induced electric field and the resultant current, so that they may be registered or displayed. These electric circuits are not described here.

A problem with the conventional fluid conductivity sensor is that it is affected by the fluid that surrounds the sensor outside of the sampling volume. The electrical current must complete its path by circulating around the sensor through the exterior fluid the fluid that is outside of the sensing volume defined by the outer- and end-walls of this sensor. This makes the measurement dependent on the conductivity of the fluid surrounding the sensor and by objects within the surrounding fluid. For example, if the fluid is not spatially homogeneous, the measurement may not represent the conductivity of the fluid within the sampling volume. If there are objects within the surrounding fluid that have a conductivity different from that of the fluid within the sensing volume, then these too will change the electric current. Highly conductive objects (metals) will increase the measured conductivity, while poorly' conductive objects (plastic and rubber) will decrease the measured conductivity. In effect, a measurement error.

### Structure and Relationship of Parts:

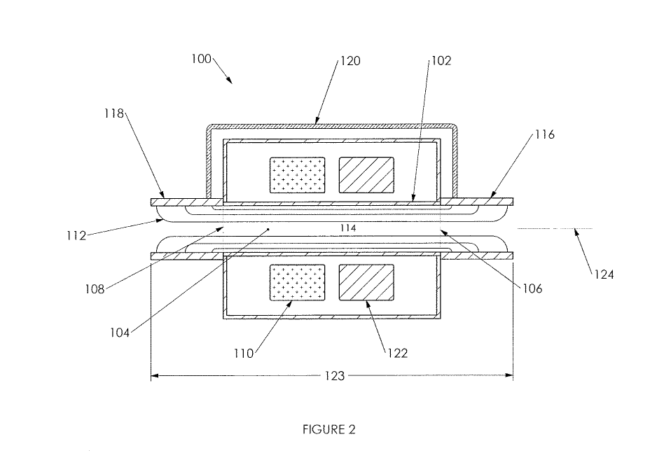

Referring to FIG. 1 and FIG. 2, electro-magnetic induction fluid conductivity sensor 100 includes a hollow non-conductive body 102 defining a fluid chamber 104. Fluid chamber 104 has a first end 106 and a second end 108. A voltage transformer 110 is provided which is capable of inducing an electric field, identified by field lines 112, into fluid 114 positioned within fluid chamber 104, thereby causing an electric current to flow through fluid 114. A first conductive element 116, is connected to body 102 at first end 106 of fluid chamber 104. A second conductive element 118 is connected to body 102 at second end 108 of fluid chamber 104. A conductive link 120 connects first conductive element 116 and second conductive element 118, thereby creating an electrical flow path for electric current in fluid 114 to flow. A current transformer 122 located coaxially with voltage transformer 110 surrounds the fluid chamber 104 to sense electric current flow. The addition of first conductive element 116 and second conductive element 118 increases the axial range of the sampling volume, as indicated by arrows 123, by extending fluid chamber 104.

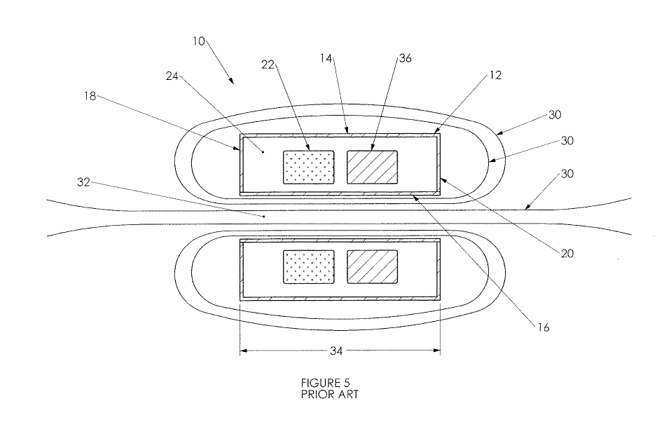

It will be understood that the configuration and geometry can differ from that which has been illustrated. For the purpose of comparison with Prior Art Sensor 10 of FIG. 5, body 102 has been illustrated as being a cylindrical body having a longitudinal axis, indicated in broken lines and identified by reference numeral 124. In this embodiment, first conductive element 116 is a first tubular metal extension and second conductive element is a second tubular metal extension 118. The first tubular metal extension constituting first conductive element 116 and the second tubular metal extension constituting second conductive element 118 are co-axial with longitudinal axis 124 of cylindrical body 102. Voltage transformer 110 is toroidal-shaped and surrounds cylinder body 102. Current transformer 122 is also toroidal-shaped and also surrounds cylinder body 102.

As will be hereinafter further described electro-magnetic induction fluid conductivity sensor 100 has a “built in” conductive shunt providing a flow path for electric current through first conductive element 116, second conductive clement 118 and conductive link 120.

### Operation:

Referring to FIG. 2, electro-magnetic induction fluid conductivity sensor 100 is not affected by the fluid, or by the objects, that surround sensor 100, and it can be immersed within the fluid to be measured. The inner wall of body 102 that forms fluid chamber 104 that contains the sensing volume is made of non-conductive material. Toroidal voltage transformer 110 induces electric field 112 in the sensing volume within fluid chamber 104 to drive an electric current through the sensing volume. A second, coaxially placed, toroidal current transformer 122 senses the resultant current. The ratio of the current to induced voltage is proportional to the electrical conductivity of the fluid.

In contrast to the Prior Art, the loop of the electric current flowing through the sampling volume is completed by the addition of a conductive shunt, which consists of first conductive element 116 and second conductive element 118, which are metal cylinders attached to the ends (first end 106 and second end 108 respectively) of the sampling volume. Conductive link 120 connects the two metal tubes (first conductive element 116 and second conductive element 118) so that the electric current can flow through a flow path around the outside of the voltage transformer 110 and current transformer 122 without entering the fluid surrounding sensor 100.

It is important to note that all electric current is confined to the sampling volume and the structure comprising sensor 100. Therefore, the current signal produced by sensor 100 in current transformer 122 is not affected by the fluid that is exterior to the sampling volume in fluid chamber 104 and the volume enclosed by the metal tubes, nor by objects that are exterior to the sensor. When the Prior Art sensor 10 was immersed within the fluid to be measured, there was a potential perturbation of the electric current flowing through the fluid chamber 104, by the fluid and objects located outside of the fluid chamber, because the electric current must complete its loop by passing around the exterior of the sensor. The exterior path caused a measurement that depends on the conductivity of the fluid and that of objects that surround the sensor. In contrast, sensor 100 eliminates this path by completing the electric loop using a current path that goes from first conductive element 116 through conductive link 120 to second conductive element 118, without interaction with fluid external to fluid chamber 104 containing the sampling volume.

### Variations:

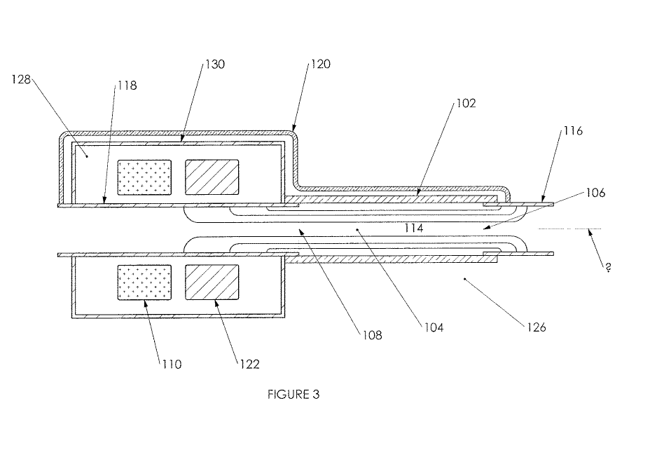

Referring to FIG. 3, in order to make abundantly clear that one may depart from the configurations illustrated in FIG. 1 and FIG. 5, there will now be illustrated and described variations.

As stated above, the configuration and geometry can differ from that which has been illustrated. The essence of the geometric variation is that any arrangement in terms of the current transformer, the voltage transformer and the sampling volume is valid as long as the intensity relation among the following three currents can be maintained precisely enough.

Current_S: the current which goes through the sampling volume,

Current_V: the current which goes through the center hole of the voltage transformer

Current_I : the current which goes through the center hole of the current transformer

In the case of the geometric variation example described here, the intensity relation is Current_S=Current_V=Current_I.

First conductive element 116 and second conductive element 118 are illustrated as metal tubes. It is to be noted that, although they must be conductive, they need not be tubular.

Similarly, conductive link 120 that connects the metal tubes which constitute first conductive element 116 and second conductive element 118 can be in a variety of forms. It can be a metal part of the outer housing of the sensor. It could be one or more metal wires, or a conductive metal mesh that is exterior to the sampling volume. The only requirement is that the conductive link 120 be outside of the current transformer 122 and the voltage transformer 110.

Referring to FIG. 3, it is not important that the transformers be situated over (or surround) the non-conductive section forming body 102 of fluid chamber 104 that holds the sampling volume. Voltage transformer 110 and current transformer 122 could be placed so that they surround one of the metal tubes. As illustrated voltage transformer 110 and current transformer 122 surround second conductive element 118 located at second end 108 of fluid chamber 104. Fluid chamber 104 holds the sampling volume with body 102 and its non-conductive wall is axially displaced. As with the first embodiment illustrated and described with reference to FIG. 1 and FIG. 2, first conductive element 116 is positioned at first end 106 of body 102, second conductive element 118 is positioned at second end 108 of body 102 and first conductive element 116 and second conductive element 118 are electrically linked by an electrical path of high conductance in conductive link 120. Such a separation of fluid chamber 104 containing the sampling volume away from voltage transformer 110 and current transformer 122 allows fluid to flow both over the inside and the outside of cylindrical body 102, as the voltage transformer 110 and current transformer 122 are disposed within a housing 128 connected to cylindrical body 102. Housing 128 has a non-conductive outer wall 130, with second conductive element 118 forming a conductive inner wall. The non-conductive outer housing 130 must be sealed against the non-conducting tube 102 so that the electric current induced in the conductive element 118 and in the fluid in the sampling volume 104 cannot enter the exterior fluid at or near the junction of the metal element 118 the non-conducting tube 102 and the housing 130.

When outside 126 of cylindrical body 102 is exposed to fluid the time of thermal equilibration of the material of cylindrical body 102 with the fluid is decreased. If the temperature of the fluid being measured is unsteady, then an incomplete thermal equilibration changes the temperature of the fluid in the sampling volume and, hence, the conductivity of the fluid in the sampling volume from the value it had before entering the sampling volume. In effect, a measurement error, because the electric conductivity of a fluid depends on its temperature as well as its concentration and composition of ions.

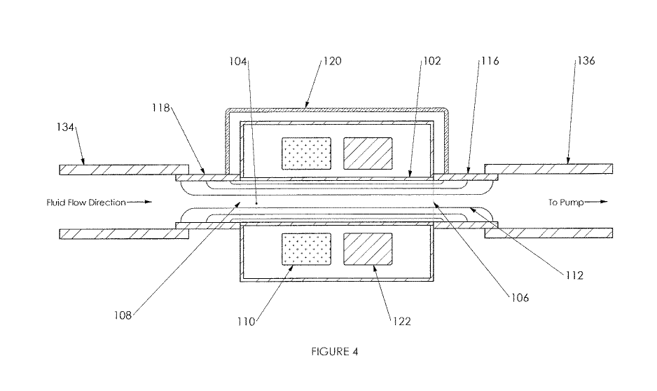

Referring to FIG. 4, a fluid inlet line 134 is connected to second end 108 of fluid chamber 104 of cylindrical body 102 and a fluid outlet line 136 is connected to first end 106 of fluid chamber 104. A pump (not shown) is then used to circulate fluid through fluid chamber 104.

Sensor 100 is not sensitive to the fluid and other materials outside of its sampling volume. It is, therefore, possible to pump fluid through fluid chamber 104 to explicitly control the speed of flow of fluid through fluid chamber 104. This is useful when sensor 100 is transiting through a fluid that is inhomogeneous in ionic concentration, or inhomogeneous in temperature, or both. The rate of thermal equilibration of cylindrical body 102 defining fluid chamber 104 containing the sampling volume with the fluid depends on the speed of the fluid flowing through fluid chamber 104 because a boundary layer forms over the surface of the wall. The speed of the fluid in the boundary layer over the wall is slower compared to that in the interior of the sampling volume that is away from the wall. The thermal (temperature) equilibration of the fluid in the boundary layer with the fluid outside of the boundary layer depends on the speed of flow, but this speed dependence is different for ions compared to heat (temperature). Keeping a constant speed of flow through the sampling volume is important when one takes concurrent measurements of fluid conductivity and its temperature in order to derive the concentration of ions in the fluid, when the fluid temperature and ionic concentration are spatially inhomogeneous, or unsteady.

### Advantages:

1. Sensor 100 can be wholly submerged within the fluid being measured.

2. Sensor 100 is not affected by the electric conductivity of fluid and other materials outside of its sensing volume.

3. As shown in FIG. 3, fluid can flow over the inside and outside surface of the tubing containing the sampling volume for accelerated thermal equilibration of the tubing and the fluid being measured.

4. As shown in FIG. 4, fluid can be forced through the sensing volume by the attachment of hoses and a pump to control the speed at which fluid flows through the sampling volume.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

1-11. (canceled)

12. An electro-magnetic induction fluid conductivity sensor comprising:
a hollow non-conductive body defining a fluid chamber, and the fluid chamber having a first end and a second end;
a voltage transformer capable of inducing an electric field into fluid positioned within the fluid chamber thereby causing an electric current to flow through the fluid;
an instrument for measuring the electric current; and
a conductive shunt for receiving the electric current induced by the voltage transformer in the fluid at the first end of the fluid chamber and returning the electric current to the second end to complete an electrical circuit,

13. The sensor of claim 12, wherein the conductive shunt comprises:
a first conductive element connected to the body at the first end of the fluid chamber;
a second conductive element connected to the body at the second end of the fluid chamber; and
a conductive link connecting the first conductive element and the second conductive element.

14. The sensor of claim 12, wherein the body is a cylinder which has a longitudinal axis.

15. The sensor of claim 12, wherein the voltage transformer is toroidal-shaped.

16. The sensor of claim 12, wherein the instrument for measuring the electric current is a current transformer.

17. The sensor of claim 16, wherein the current transformer is toroidal-shaped.

18. The sensor of claim 16, wherein the body is a cylinder, the voltage transformer is toroidal-shaped and surrounds the cylinder body and the current transformer is toroidal-shaped and surrounds the cylinder body.

19. The sensor of claim 2, wherein the body is a cylinder which has a longitudinal axis, the first conductive element is a first tubular metal extension and the second conductive element is a second tubular metal extension, and the first tubular metal extension and the second tubular metal extension are co-axial with the longitudinal axis of the cylinder body.

20. The sensor of claim 13, wherein the instrument for measuring the electric current is a current transformer, and the voltage transformer and the current transformer are disposed within a housing connected to the body with the second conductive element forming a conductive inner wall for the housing.

21. The sensor of claim 20, wherein the voltage transformer is toroidal-shaped and surrounds the conductive inner wail and the current transformer is toroidal-shaped and surrounds the conductive inner wall,

22. The sensor of claim 12, wherein a fluid inlet line is connected to one of the first end or the second end of the body and a fluid outlet line is connected to another of the first end or the second end of the body, and fluid is circulated through the fluid chamber.
